(19) United States
(12) Patent Application Publication
(10) Pub. No.: US 2019/0233331 A1
(43) Pub. Date: Aug. 1, 2019

(54) METHOD OF USING FLY ASH

(71) Applicant: TOKUYAMA CORPORATION, Shunan-shi, Yamaguchi (JP)

(72) Inventors: Kohei OMURA, Shunan-shi (JP); Takuya SEKI, Shunan-shi (JP)

(73) Assignee: TOKUYAMA CORPORATION, Shunan-shi, Yamaguchi (JP)

(21) Appl. No.: 16/315,091

(22) PCT Filed: Jun. 29, 2017
(86) PCT No.: PCT/JP2017/023938

§ 371 Date: Jan. 3, 2019

(30) Foreign Application Priority Data
Jul. 4, 2016 (JP) 2016-132651

(51) Int. Cl. C04B 18/08; B09B 5/00; C04B 28/02; C04B 7/32; C04B 7/38

(52) U.S. Cl. CPC C04B 18/08; B09B 5/00; B09B 2220/06; C04B 7/32; C04B 7/38; C04B 28/02

(57) ABSTRACT

A sieve with a mesh opening of 75 to 20 μm is provided. A raw fly ash powder is separated into a component remaining on the sieve and a component passing through the sieve by classification using the sieve. A fine fly ash powder, which is the component passing through the sieve, is used as a cement admixture. A coarse fly ash powder, which is the component remaining on the sieve, is used for production of cement clinker.

This invention relates to a method of using fly ash. More specifically, the invention relates to a method of using fly ash, the method in which fly ash discharged from a thermal power plant is used in two forms, namely, a raw material for production of cement clinker, and a material for use in mixture with cement, such as a cement admixture or a concrete admixture.

### BACKGROUND ART

Cement widely used in fields such as civil engineering and construction is a mixture consisting essentially of tricalcium silicate (alite; C₃S), dicalcium silicate (belite; C₂S), calcium aluminate (aluminate; C₃A), calcium aluminoferrite (ferrite; C₄AF), and calcium sulfate (gypsum), and is a powder having the property of hardening upon mixing with water. Such cement is produced by mixing gypsum and, if required, various admixtures, with a pulverized product of clinker containing alite, belite, aluminate and ferrite, and pulverizing the resulting mixture.

As will be understood from the above explanation, clinker (may be called cement clinker) contains CaO, SiO₂, Al₂O₃ and Fe₂O₃, and is obtained by mixing limestone, clay, silica stone-, slag, etc. and calcining the mixture at a high temperature.

When the above cement is mixed with water, a cement paste is obtained. A material formed by kneading sand (fine aggregate) and pebbles (gravel) into the cement paste until solidification is called concrete. A material formed by merely kneading sand into the cement paste is called mortar.

Coal ash occurring in a coal-fired power plant or the like includes clinker ash recovered from a water tank at the bottom of a boiler, and fly ash recovered from an electrostatic precipitator. Both types of ash consist essentially of SiO₂ (silica) and Al₂O₃ (alumina), and they are used mostly as an SiO₂ source and an Al₂O₃ source for the manufacture of cement clinker. As other uses, clinker ash is used frequently in civil engineering-related fields, because it is a sandy porous particulate and is thus satisfactory in light weight, water drainage, air permeability, water retention, etc. On the other hand, fly ash is spherical particles, and is used as a cement admixture for the production of cement upon mixing with clinker, gypsum or the like, and further finds use as a concrete admixture for the manufacture of concrete or mortar.

Nowadays, the amount of fly ash usable for clinker manufacturing in Japan nearly reaches its limit. In recent years, Japan has faced a growing demand for thermal power generation, because of a desire for reduced reliance on nuclear power generation and for electric power liberalization. In accordance with these moves, the amount of fly ash formed as a by-product has shown a tendency to increase.

Hence, it is desired to increase the amount of fly ash used as a raw material for clinker. However, there is a limit to the amount of fly ash used per unit production amount of clinker.

That is, it is known that when clinker is produced using an excess of fly ash, the amount of aluminate (C₃A) increases, with the result that a paste formed by mixing water with cement prepared by mixing such clinker with gypsum or the like cakes in a short time and decreases in flowability. Thus, Patent Document 1 proposes the measure of adding CuO to avoid inconveniences due to the aluminate increase.

Furthermore, the excessive use of fly ash is reported to decrease the amount of the alite phase (C₃S), leading to a decline in the strength developability in the initial to middle stage of cement. In order to avoid such inconveniences, Patent Document 2 proposes the measure of adding 2 to 10% by weight of a fine limestone powder to clinker with a low alite content, thereby suppressing a fall in the strength in the initial to middle stage of cement.

As described above, increasing the amount of fly ash for use in clinker production requires the addition of CuO, limestone or the like. As a result, the composition of clinker or cement changes, thus causing changes in the physical properties of clinker or cement as well. Under these circumstances, there is need to increase the consumption of fly ash without using a particular compounding agent such as CuO or limestone. For this purpose, it is currently desired to use fly ash not only as a raw material for clinker production, but also as a cement admixture or a concrete admixture (will hereinafter be referred to simply as an admixture), for use in the production of cement, and further for the production of concrete or mortar as well.

Concrete or mortar prepared using cement mixed with fly ash is advantageous over the one not using fly ash in that its long-term strength improves, the reaction between alkali and silica is suppressed, its workability is enhanced, and the resulting heat of hydration is reduced. Fly ash, however, is problematical from the viewpoint of stability of quality. That is, depending on the properties of fuel used in power generation or the operating status of a boiler, the resulting fly ash differs in ignition loss (corresponding to the amount of unburned carbon), reactivity with cement, etc. Such physical properties of fly ash influence the characteristics of concrete or mortar as a final product. Thus, fly ash usable as an admixture (admixture to be incorporated into cement or concrete) complies with quality standards. Under quality standards such as JIS A-6201 in Japan, and ASTM C618 (CLASS F) in the United States, for example, certain reference values concerned with ignition loss, etc. are set for the usable fly ash.

If fly ash, which does not satisfy the above quality standards, for example, whose ignition loss exceeds the reference value (i.e., higher in unburned carbon content), is used as an admixture with cement, there is a high possibility for the occurrence of a problem such that unburned carbon floats to the surface of mortar or concrete, generating a black region. Moreover, the unburned carbon adsorbs an expensive chemical admixture such as an air entraining and water reducing agent, thus deteriorating the workability of mortar or concrete, or disadvantaging the cost.

In using fly ash as an admixture or the like by mixing it with cement, therefore, it is necessary to remove unburned carbon from fly ash beforehand, but it has been unsuccessful to separate unburned carbon from fly ash while maintaining other quality properties.

Patent Document 3, for example, describes a technology which comprises introducing air at a high temperature of 400 to 1000° C. and fly ash into a cyclone, heating the fly ash to burn and remove unburned carbon, then dividing the fly ash deprived of the unburned carbon into a coarse powder and a fine powder by a classifier, and utilizing the fine powder as an admixture with cement.

According to the findings of the present inventors, however, if unburned carbon is removed by heating, the inherent reactivity of fly ash with cement may decline, or a ball bearing effect may fail to be exhibited owing to the sintering or the like of particles of the fly ash, resulting in the lowering of flowability.

Patent Document 4 proposes a technology which comprises sifting fly ash through a sieve of 250 μm or more, and using the resulting fine particles as fly ash complying with the JIS standards. With this technology, coarse particles contain a large amount of unburned carbon, but have activated carbon-like properties and a high content of adsorbed iodine, and their use for a water quality improver or the like is recommended. Moreover, the fine particles may contain a large amount of unburned carbon and may fail to ensure quality as an admixture.

### PRIOR ART DOCUMENTS

### Patent Documents

Patent Document 1: Japanese Patent No. 5535111

Patent Document 2: Japanese Patent No. 3760708

Patent Document 3: Japanese Patent No. 3205770

Patent Document 4: JP-A-2001-121084

### SUMMARY OF THE INVENTION

### Problems to be Solved by the Invention

It is an object of the present invention, therefore, to provide a method of using fly ash, the method comprising using a raw fly ash powder in divided forms, i.e., a raw material for clinker production and an admixture with cement, thereby rendering all of the raw fly ash powder consumable, and making it possible to produce concrete or mortar without causing changes in the composition or physical properties.

### Means for Solving the Problems

In an attempt to solve the above-mentioned problems, the present inventors conducted intensive studies. As a result, they have found that when a raw fly ash powder is subjected to a sieve with a mesh opening of 75 to 20 μm, its component remaining on the sieve (coarse fly ash powder) has a low proportion of Al₂O₃ compared with SiO₂, and can be used preferably as a raw material for clinker production, whereas its component passing through the sieve (fine fly ash powder) has a low unburned carbon content, and has quality suitable for an admixture. These findings have led them to accomplish the present invention.

According to the present invention, there is provided a method of using fly ash, comprising:

providing a sieve with a mesh opening of 75 to 20 μm;

separating fly ash discharged from a thermal power plant into a component remaining on the sieve and a component passing through the sieve by classification using the sieve;

using a fine fly ash powder, which is the component passing through the sieve, in admixture with cement; and

using a coarse fly ash powder, which is the component remaining on the sieve, for production of cement clinker.

In the present invention, it is preferred that

(1) the fine fly ash powder be used for production of concrete or mortar through its use as a mixture with cement.

### Effects of the Invention

The present invention subjects fly ash, which has been discharged from a thermal power plant, to a very simple measure which comprises separating the fly ash into a coarse powder and a fine powder with the use of a sieve having a certain mesh opening. By so doing, the invention can obtain fly ash suitable for clinker production (i.e., coarse powder), and fly ash suitable for use as an admixture with cement (i.e., fine powder). For example, the invention permits the effective use of the total amount of fly ash collected from an electrostatic precipitator of a coal-fired power plant. If the ignition loss of the fly ash discharged exceeds 5.0% by mass, in particular, the invention is highly useful.

That is, the coarse powder, which is the component remaining on the sieve, has a low Al₂O₃/SiO₂ mass ratio, as will be understood from the experimental results of a working example to be described later. Thus, without causing an increase in aluminate or without the addition of a particular material, the coarse powder makes it possible to produce clinker having the same composition and physical properties as those of publicly known ones, and to increase the amount of fly ash used as a raw material for clinker production.

The fine powder, which is the component passing through the sieve, has a low unburned carbon content (a small ignition loss), and fulfills the quality required of an admixture. Such a fine fly ash powder can be used as a mixture with gypsum or clinker for the preparation of cement, and can be further used in mixture with separately produced cement. Through such a form of use, the fine powder can be used for the production of concrete or mortar.

### MODE FOR CARRYING OUT THE INVENTION

### <Fly Ash>

Fly ash is matter which is caught by a dust collector from dust and soot generated during a combustion process. In the present invention, fly ash collected by an electrostatic precipitator of a coal-fired power plant is preferably used, particularly because it occurs in a large amount, it can be industrially utilized, and it has constant quality.

In the present invention, a raw fly ash powder collected by the electrostatic precipitator generally contains silica (SiO₂) in an amount of 40% by mass or more, especially 45 to 60% by mass, and alumina (Al₂O₃) in an amount of 15% by mass or more, especially 20 to 35% by mass or more, the SiO₂/Al₂O₃ mass ratio being in a range of the order of 1.5 to 2.5, and further contains Fe₂O₃, MgO, and CaO as other oxides. The ignition loss (corresponding to the unburned carbon content) at 1000° C. is of the order of 3 to 6% by mass. The particle size of the raw powder is in a wide range and, on the average, of the order of 10 to 50 μm.

### <Classification>

In the present invention, the raw fly ash powder is classified into a coarse powder and a fine powder, and the fine powder is used as an admixture, while the coarse powder is used as a raw material for clinker production. It is important that this classification be performed using a sieve. That is, as will be shown in the working example to be described later, a fine powder deprived of unburned carbon particles can be obtained by classification using a sieve having a certain mesh opening, and such a fine powder can be used as an admixture. The coarse powder has a low Al₂O₃ content as compared with the raw powder, and can be used preferably as a raw material for clinker production.

Airflow classification, for example, is available as a classification means which is employed industrially. Such a means, however, cannot separate the unburned carbon particles from the fine powder, because the unburned carbon particles, owing to their low specific gravity, are recovered in a form contained in the fine powder used as an admixture. In this case, therefore, the measure of heating the recovered fine powder to remove the unburned carbon particles by combustion is adopted, but such heating lowers the inherent reactivity of the fly ash with cement to impair the aptitude of the fine powder for use as an admixture.

In the present invention, as noted above, the raw fly ash powder is classified into the coarse powder and the fine powder with the use of the sieve. As the sieve, one with a mesh opening of 75 to 20 μm, particularly 63 to 20 μm, is used, and more preferably one with a mesh opening of 45 μm or more is used.

The classification using the sieve with such a mesh opening greatly reduces the unburned carbon content in the fine fly ash power which is the component passing through the sieve. Consequently, a fine fly ash powder having a high quality as an admixture without deterioration of its reactivity with cement is obtained. That is, the unburned carbon particles contained in the raw fly ash powder contain a large amount of particles with such a particle size as not to pass through the sieve with the above mesh opening.

As will be indicated by the working example to be described later, the coarse fly ash powder which is the component remaining on the sieve has an alumina content decreased compared with the raw powder (silica/alumina mass ratio increased), so that a coarse fly ash powder having a high aptitude for use as a raw material for cement clinker production is obtained. That is, the alumina component contained in the raw fly ash powder contains a large amount of particles with such a small particle size as to pass through the sieve with the above mesh opening.

If a sieve with a greater mesh opening than the above mesh opening is used to perform classification, for example, the amount of the unburned carbon particles in the component passing through the sieve increases, thereby impairing the aptitude of the fine powder, which is the component passing through the sieve, for use as an admixture. Moreover, the recovery rate of the coarse powder lowers, thus decreasing the yield of the raw material for clinker production.

If a sieve having a smaller mesh opening than the mesh opening mentioned above is used, particles with a high Al₂O₃ content do not pass through the meshes of the sieve. As a result, the SiO₂/Al₂O₃ mass ratio of the coarse powder nearly equals that of the raw powder, and the aptitude of the coarse powder as a raw material for clinker production is impaired. Furthermore, clogging of the sieve meshes is apt to occur, and the durability of the sieve also declines.

In the present invention, a publicly known classifier, for example, a gyrating airflow sieving machine, a centrifugal airflow sieving machine, a centrifugal dispersing sieving machine, a round vibrating sieving machine, or a shaking sieving machine, can be used as the above classifier, as long as classification by a sieve with the aforementioned mesh opening is performed thereby.

Of these classifiers, the centrifugal dispersing sieving machine has the advantage that its treating capacity per screen (sieve) unit area is high. Moreover, it has the advantage of being able to effectively classify fly ash (coarse powder) even if the fly ash contains water and agglomerates highly.

Further, the shaking sieve is inferior to the centrifugal dispersing sieving machine in the treating capacity per screen unit area, but lightens a load on the main body of the machine due to vibrations. Thus, this machine is effective particularly when classifying a large amount of fly ash.

### <Fine Fly Ash Powder>

In the present invention, 80% to 90% of the original fly ash is obtained as a fine fly ash powder by classification using the sieve mentioned above. The fine fly ash powder is effectively deprived of unburned carbon by classification. Compared with the raw fly ash powder, therefore, the fine fly ash powder is lower in the unburned carbon content. For example, its ignition loss at 1,000° C. is 4.0% by mass or less and, depending on the composition of the raw powder, is 3.0% by mass or less.

Furthermore, such a fine fly ash powder has not been subjected to heating for removing the unburned carbon, and thus its reactivity with cement has not been lowered. For example, in accordance with JIS A 6201, etc., the proportion (%) of compressive strength, as measured in connection with mortar incorporating a predetermined amount of the fine fly ash powder, to the compressive strength of reference mortar is known as an activity index. The activity index of the fine fly ash powder obtained by the present invention is 80% or more after a lapse of 28 days, and 90% or more after a lapse of 91 days.

As shown above, the fine fly ash powder obtained using the aforementioned sieve satisfies the values of the ignition loss and the activity index required by quality standards such as JIS A 6201 and ASTM C618 (CLASS F).

In the present invention, therefore, the above-mentioned fine fly ash powder is used in mixture with cement. Concretely, the fine powder is mixed with cement containing gypsum or clinker and used, or the fine powder and other components are simultaneously mixed and used for the preparation of cement. In this case, a composition formed by mixing is usually called cement, depending on the standards of each country. If a large amount of fly ash is mixed, for example, the mixture is called fly ash cement.

Such cement may further contain other admixtures used where necessary (ground granulated blast furnace slag, fine limestone powder, siliceous admixture, etc.). Any of gypsum dihydrate, gypsum hemihydrate, and anhydrous gypsum can be used as gypsum.

The fine powder can also be mixed with various cements produced separately (for example, Portland cement, blast furnace cement, and blended cement) for the purpose of use in adjusting the physical properties of the cement. Furthermore, when a cement paste is to be prepared by mixing water with cement, or when a fine aggregate or the like is kneaded with this cement paste to produce concrete or mortar, the fine fly ash powder can be mixed.

### <Coarse Fly Ash Powder>

In the present invention, 10% to 20% of the raw fly ash powder is obtained as a coarse fly ash powder (i.e., component remaining on the sieve) by classification using the sieve mentioned above.

Compared with the raw powder, the coarse fly ash powder is increased in the unburned carbon content. However, its SiO₂/Al₂O₃ mass ratio is increased, and thus the Al₂O₃ content is decreased. As the mesh opening of the sieve increases, in particular, this tendency becomes higher. When the sieve with a mesh opening of 45 μm or more is used on condition that the mesh opening is in the aforementioned range, a great reduction in the Al₂O₃ content is confirmed.

Hence, the coarse fly ash powder is used as a raw material for clinker production, whereby the amount of fly ash used per unit weight of clinker can be increased. That is, the coarse fly ash powder has a low Al₂O₃ content, so that the amount of the resulting aluminate (C₃A) can be kept down. Thus, the amount of the coarse fly ash powder used can be increased. Assume that the amount of the coarse fly ash powder used per unit weight of clinker is 100, for example. If this coarse powder is used in this case, its amount of use can be set at 110 or more.

Clinker production using the coarse fly ash powder is performed by mixing the coarse fly ash powder with various inorganic materials, concretely, limestone, clay, silica stone, slag, etc., in such a manner that CaO, SiO₂, Al₂O₃ and Fe₂O₃ necessary for the formation of a cement component are supplied, and then calcining the mixture at a high temperature. By using such a coarse fly ash powder, it becomes possible to reduce the amounts of clay and silica stone used, which serve as SiO₂ and Al₂O₃ sources, thereby achieving cost reduction.

### Examples

Hereinbelow, the present invention will be described more concretely by reference to experimental examples, but the present invention is in no way limited to these experimental examples.

<Raw Fly Ash Powder>

Five raw fly ash powders (to be described hereinafter as FA1 to FA5) occurring in different coal-fired power plants in Japan were used.

### <Classification>

### Sieve:

A JIS testing sieve (JIS Z 8801-1:2006) made of stainless steel, which had a mesh opening of 75, 45 or 20 μm, was used. All of these sieves used were circular sieves with a screen diameter of 200 mm.

An ultrasonic vibration generator (PNS35-50/100-S/T, a product of Artech) was mounted with the above JIS testing sieve, and classification was performed, with ultrasonic vibrations being applied to the sieve.

### <Various Evaluation Methods>

### Ignition Loss:

The ignition loss of the resulting coarse or fine fly ash powder was measured in accordance with the method specified in JIS A 6201:2015.

### Activity Index:

The activity index of the resulting fine fly ash powder was measured in accordance with the method specified in JIS A 6201:2015.

### Chemical Composition:

The contents (% by mass) of SiO₂, Al₂O₃ and other components of the resulting coarse fly ash powder were determined by X-ray fluorescence analysis using an X-ray fluorescence analyzer. The values were calculated so that the total value of the ignition loss (unburned carbon content) and the content of each component would be 100% by mass.

### Example

FA1 to FA3 were classified using the sieve to obtain coarse fly ash powders and fine fly ash powders. The yields of the resulting coarse fly ash powders are shown in Table 1.

TABLE 1

| | FA1 | FA2 | FA3 | Average |
|---|---|---|---|---|
| 75 μm coarse | 4.6 | 12.7 | 9.7 | 9.0 |
| powder | | | | |
| 45 μm coarse | 10.0 | 22.7 | 17.9 | 16.9 |
| powder | | | | |
| 20 μm coarse | 24.2 | 42.6 | 36.7 | 34.5 |
| powder | | | | |

(unit: mass %)

The above results show that when the raw fly ash powder was classified using the sieve with a mesh opening of 45 μm, the coarse fly ash powder was obtained in an amount of 16.9% by mass on the average relative to the raw powder.

The resulting coarse fly ash powders were each measured for the ignition loss at 1,000° C. and the chemical composition, and the SiO₂/Al₂O₃ mass ratio was calculated. The results are shown in Table 2.

TABLE 2

| | | | Component | | | |
|---|---|---|---|---|---|---|
| | | Ignition loss | (mass %) | | | SiO₂/ |
| | | (mass %) | SiO₂ | Al₂O₃ | others | Al₂O₃ |
| FA1 | Raw powder | 5.3 | 51.8 | 25.8 | 17.1 | 2.0 |
| | 75 μm coarse | 17.3 | 48.3 | 20.9 | 13.5 | 2.3 |
| | powder | | | | | |
| | 45 μm coarse | 9.2 | 50.2 | 22.6 | 18.0 | 2.2 |
| | powder | | | | | |
| | 20 μm coarse | 9.0 | 50.8 | 24.0 | 16.2 | 2.1 |
| | powder | | | | | |
| FA2 | Raw powder | 4.2 | 58.8 | 26.4 | 10.6 | 2.2 |
| | 75 μm coarse | 29.1 | 48.5 | 15.5 | 7.0 | 3.1 |
| | powder | | | | | |
| | 45 μm coarse | 17.1 | 54.3 | 19.3 | 9.4 | 2.8 |
| | powder | | | | | |
| | 20 μm coarse | 11.3 | 56.8 | 22.1 | 9.9 | 2.6 |
| | powder | | | | | |
| FA3 | Raw powder | 3.5 | 48.3 | 31.1 | 17.2 | 1.6 |
| | 75 μm coarse | 9.3 | 45.9 | 27.6 | 17.1 | 1.7 |
| | powder | | | | | |
| | 45 μm coarse | 5.8 | 47.0 | 28.5 | 18.8 | 1.7 |
| | powder | | | | | |
| | 20 μm coarse | 4.6 | 48.6 | 30.0 | 16.8 | 1.6 |
| | powder | | | | | |

The above results show that the coarse fly ash powder underwent a great ignition loss. Moreover, the coarse fly ash powder was shown to be low in the Al₂O₃ content, with the result that its SiO₂/Al₂O₃ mass ratio was high.

The resulting coarse fly ash powder was used as a substitute material for the raw fly ash powder to produce clinker. The amount of each of the raw powders FA1 to FA3 used as the raw material for clinker production was taken as 100%, and the amount of the coarse fly ash powder used was determined. The results are shown in FIG. 3. The amount of use was calculated from the ratio between the Al₂O₃ contents of the raw powder and the coarse powder. For example, the Al₂O₃ content in the 75 μm coarse powder from FA1 was 20.9 compared with 25.8 of the raw powder, the ratio being as low as 20.9/25.8=1/1.235. That is, in supplying Al₂O₃ necessary for clinker production with the use of the 75 μm coarse powder, the amount of 123.5% is usable in comparison with the raw powder.

TABLE 3

| | FA1 | FA2 | FA3 | Average |
|---|---|---|---|---|
| Raw powder | 100 | 100 | 100 | 100 |
| 75 μm coarse | 123.5 | 170.6 | 112.4 | 135.5 |
| powder | | | | |
| 45 μm coarse | 113.9 | 137.0 | 109.0 | 119.9 |
| powder | | | | |
| 20 μm coarse | 107.4 | 119.4 | 103.7 | 110.2 |
| powder | | | | |

(unit: mass %)

The above results demonstrate that when the coarse fly ash powder obtained by classification using the sieve with a mesh opening of 45 μm was used, an average of 119.9% by mass of fly ash could be used compared with the use of the raw fly ash powder. The possibility for the increase in the amount of fly ash used would be ascribed to the facts that the SiO₂/Al₂O₃ mass ratio of the coarse fly ash powder was high and that its ignition loss was also great.

The FA1 to FA3 and the raw fly ash powders thereof were classified using the sieve with a mesh opening of 75, 45 or 20 μm. The ignition loss and activity index of each of the resulting fine fly ash powders were measured, and the results of the measurements are shown in Table 4. As a reference, the specified values of JIS Class II fly ash highly versatile as fly ash for an admixture are also shown in Table 4.

TABLE 4

| | | | Activity | Activity |
|---|---|---|---|---|
| | | Ignition | index | index |
| Example | | loss | 28 days | 91 days |
| FA1 | Raw powder | 5.3 | 81 | 94 |
| | 75 μm fine powder | 4.0 | 84 | 99 |
| | 45 μm fine powder | 3.5 | 82 | 98 |
| | 20 μm fine powder | 3.2 | 89 | 105 |
| FA2 | Raw powder | 4.2 | 83 | 99 |
| | 75 μm fine powder | 3.0 | 83 | 101 |
| | 45 μm fine powder | 2.3 | 84 | 101 |
| | 20 μm fine powder | 2.0 | 87 | 103 |
| FA3 | Raw powder | 3.5 | 83 | 97 |
| | 75 μm fine powder | 2.6 | 86 | 98 |
| | 45 μm fine powder | 2.4 | 87 | 100 |
| | 20 μm fine powder | 2.7 | 87 | 100 |

| | | | |
|---|---|---|---|
| JIS Class II | 5.0 or less | 80 or more | 90 or more |

The fine fly ash powder was shown to be smaller in the ignition loss and lower in the unburned carbon content than the raw fly ash powder. The fine fly ash powder was also shown to be higher in the activity index than the raw fly ash powder, and thus be superior in the reactivity with a cement composition.

### Comparative Example

In connection with FA4 and FA5, the ignition loss and the activity index after heat treatment were measured. The results of the measurements are shown in FIG. 5. As the heat treatment, FA4 and FA5 were heated for 10 minutes in an electric furnace held at 800° C. or 1,000° C., whereafter they were air-cooled at room temperature to obtain samples. As a reference, the specified values of JIS Class II fly ash highly versatile as fly ash for an admixture are also shown in Table 5.

TABLE 5

| | | | Activity | Activity |
|---|---|---|---|---|
| Comparative | | Ignition | index | index |
| Example | | loss | 28 days | 91 days |
| FA4 | raw powder | 4.0 | 81 | 96 |
| | after heating at 800° C. | 1.1 | 80 | 94 |
| | after heating at 1000° C. | 0.8 | 80 | 94 |
| FA5 | raw powder | 3.7 | 80 | 95 |
| | after heating at 800° C. | 1.0 | 79 | 93 |
| | after heating at 1000° C. | 0.5 | 76 | 87 |

| | | | |
|---|---|---|---|
| JIS Class II | 5.0 or less | 80 or more | 90 or more |

Table 5 shows that when heated, fly ash decreased in the ignition loss and had the unburned carbon removed by combustion. On the other hand, the heated fly ash lowered in the activity index, and thus its reactivity with cement was low.

1. A method of using fly ash, comprising:
providing a sieve with a mesh opening of 75 to 20 μm;
separating fly ash discharged from a thermal power plant into a component remaining on the sieve and a component passing through the sieve by classification using the sieve;
using a fine fly ash powder, which is the component passing through the sieve, in admixture with cement; and
using a coarse fly ash powder, which is the component remaining on the sieve, for production of cement clinker.

2. The method of using according to claim 1, wherein the fine fly ash powder is used for production of concrete or mortar through its use as a cement admixture or a concrete admixture.
